(19) United States
(12) Patent Application Publication
(10) Pub. No.: US 2023/0290099 A1
(43) Pub. Date: Sep. 14, 2023

(54) METHOD AND APPARATUS FOR RECONSTRUCTING THREE-DIMENSIONAL, DEVICE AND STORAGE MEDIUM

(71) Applicant: Zhejiang SenseTime Technology Development Co., Ltd., Hangzhou (CN)

(72) Inventors: Hujun BAO, Hangzhou (CN); Xiaowei ZHOU, Hangzhou (CN); Jiaming SUN, Hangzhou (CN); Yiming XIE, Hangzhou (CN)

(73) Assignee: Zhejiang SenseTime Technology Development Co., Ltd., Hangzhou (CN)

(21) Appl. No.: 18/318,724

(22) Filed: May 17, 2023

Related U.S. Application Data
(63) Continuation of application No. PCT/CN2021/102117, filed on Jun. 24, 2021.

(30) Foreign Application Priority Data
Jan. 15, 2021 (CN) 202110057035.9

(51) Int. Cl. G06T 19/20; G06T 5/00; G06T 5/50; G06T 3/40; G06T 7/80

(52) U.S. Cl. CPC G06T 19/20; G06T 5/002; G06T 5/50; G06T 3/4053; G06T 7/80; G06T 2219/2016; G06T 2210/36; G06T 2207/20084; G06T 2200/08

(57) ABSTRACT

A method for reconstructing three-dimensional includes the following operations. At least two frames of first key images for current reconstruction are acquired. A first space surrounding visual cones of the at least two frames of the first key images is determined. The first key images are obtained by photographing a to-be-reconstructed target. A first feature map of the first space is determined based on image information in the several frames of the first key images. The first feature map includes first feature information of voxels in the first space. A first reconstruction result of the current reconstruction is obtained based on the first feature map. A second reconstruction result obtained by previous reconstruction is updated based on the first reconstruction result of the current reconstruction.

### CROSS-REFERENCE TO RELATED APPLICATIONS

This is a continuation of International Application No. PCT/CN2021/102117 filed on Jun. 24, 2021, which claims priority to Chinese patent application No. 202110057035.9 filed on Jan. 15, 2021. The disclosures of the above-referenced applications are hereby incorporated by reference in their entirety.

### BACKGROUND

With the development of electronic information technology, performing three-dimensional reconstruction on objects in real scenarios through electronic devices integrated with cameras such as mobile phones and tablet computers has been widely used in many application scenarios. For example, it may be applied to downstream applications such as Augmented Reality (AR). In order to enhance the immersion between AR effect and physical scenario, the three-dimensional reconstruction result needs to be as smooth as possible, and the three-dimensional reconstruction process needs to be as real-time as possible. In view of this, how to improve the real-time performance of three-dimensional reconstruction process and the smoothness of three-dimensional reconstruction results has become a topic of great research value.

### SUMMARY

The disclosure relates to the field of computer vision, and in particular to a method and apparatus for reconstructing three-dimensional, a device and storage medium.

The embodiments of the present disclosure provide a method and apparatus for reconstructing three-dimensional, a device and storage medium.

The embodiments of the present disclosure provide a method for reconstructing three-dimensional. The method includes the following operations. At least two frames of first key images for current reconstruction are acquired. A first space surrounding visual cones of the at least two frames of the first key images is determined. The first key images are obtained by photographing a to-be-reconstructed target. A first feature map of the first space is obtained based on image information in the at least two frames of the first key images. The first feature map includes first feature information of voxels in the first space. A first reconstruction result of the current reconstruction is obtained based on the first feature map. A second reconstruction result obtained by previous reconstruction is updated based on the first reconstruction result of the current reconstruction.

The embodiments of the present disclosure provide an apparatus for reconstructing three-dimensional. The apparatus includes a key images acquiring module, a first space determining module, a first feature acquiring module, a reconstruction result acquiring module, and a reconstruction result updating module. The key images acquiring module is configured to acquire at least two frames of first key images for current reconstruction. The first space determining module is configured to determine a first space surrounding visual cones of the at least two frames of the first key images. The first key images are obtained by photographing a to-be-reconstructed target. The first feature acquiring module is configured to obtain a first feature map of the first space based on image information in the at least two frames of the first key images. The first feature map comprises first feature information of voxels in the first space. The reconstruction result acquiring module is configured to obtain a first reconstruction result of the current reconstruction based on the first feature map. The reconstruction result updating module is configured to update, based on the first reconstruction result of the current reconstruction, a second reconstruction result obtained by previous reconstruction.

The embodiments of the present disclosure provide an electronic device, which includes a memory and a processor that are mutually coupled. The processor is configured to execute program instructions stored in the memory to implement the above method for reconstructing three-dimensional.

The embodiments of the present disclosure provide a computer-readable storage medium on which program instructions are stored. When the program instructions are executed by a processor, the method for reconstructing three-dimensional is implemented.

### BRIEF DESCRIPTION OF THE DRAWINGS

In order to describe the technical solutions of the embodiments of the present disclosure more clearly, the following briefly introduces the accompanying drawings which may be used in the embodiments. The accompanying drawings are incorporated into the description and constitute a part of the description. The drawings illustrate embodiments consistent with the present disclosure, and together with the description serve to explain the technical solutions of the present disclosure. It should be understood that the following drawings only show some embodiments of the present disclosure, and therefore should not be regarded as limiting the scope. For those of ordinary skill in the art, other related drawings can also be obtained from these drawings without any creative effort.

FIG. 1A is a schematic flowchart of an embodiment of a method for reconstructing three-dimensional according to some embodiments of the present disclosure.

FIG. 1B shows a schematic diagram of a system architecture of a method for reconstructing three-dimensional according to some embodiments of the present disclosure.

FIG. 2 is schematic diagram of an embodiment of the first space.

FIG. 3 is a schematic process diagram of an embodiment of a method for reconstructing three-dimensional according to some embodiments of the present disclosure.

FIG. 4 is a schematic diagram of the effects of a method for reconstructing three-dimensional according to some embodiments of the present disclosure and other method for reconstructing three-dimensional.

FIG. 5 is schematic flowchart of an embodiment of step S12 in FIG. 1A.

FIG. 6 is a state schematic diagram of an embodiment of acquiring a first feature map.

FIG. 7 is schematic flowchart of an embodiment of step S13 in FIG. 1A.

FIG. 8 is a state schematic diagram of an embodiment of acquiring the current hidden layer state.

FIG. 9 is a schematic process diagram of another embodiment of a method for reconstructing three-dimensional according to some embodiments of the present disclosure.

FIG. 10 is schematic frame diagram of an embodiment of an apparatus for reconstructing three-dimensional according to some embodiments of the present disclosure.

FIG. 11 is a schematic frame diagram of an embodiment of an electronic device according to some embodiments of the present disclosure.

FIG. 12 is a schematic frame diagram of an embodiment of a computer-readable storage medium according to some embodiments of the present disclosure.

### DETAILED DESCRIPTION

The technical solutions of the embodiments of the present disclosure will be described in detail below with reference to the accompanying drawings.

In the following description, for the purpose of illustration rather than limitation, details such as specific system structures, interfaces, and technologies are set forth to provide a thorough understanding of the embodiments of the present disclosure.

The terms “system” and “network” can often be used interchangeably herein. The term “and/or” in the present disclosure is only an association relationship to describe the associated objects, indicating that there can be three kinds of relationships, for example, A and/or B may indicate three situations: A exists alone, A and B exist at the same time, and B exists alone. In addition, the character “/” in the present disclosure generally indicates that the associated objects before and after are an “or” relationship. In addition, “multiple” herein means two or more than two.

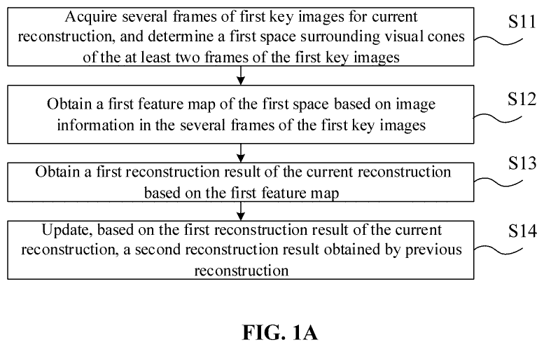

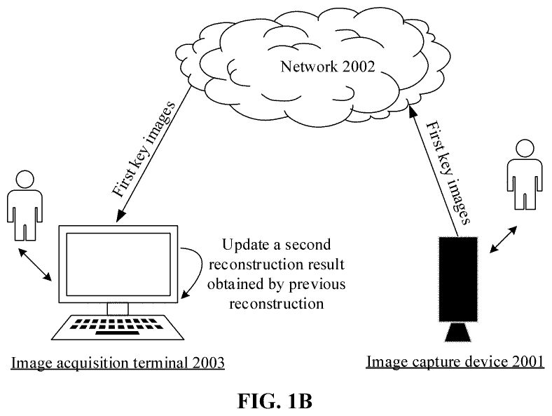

Referring to FIG. 1A, FIG. 1A is a schematic flowchart of an embodiment of a method for reconstructing three-dimensional according to the embodiments of the present disclosure. The method includes the following steps.

In step S11, at least two frames of first key images for current reconstruction are acquired. A first space surrounding visual cones of the at least two frames of the first key images is determined.

In the embodiments of the present disclosure, the first key images are obtained by photographing the to-be-reconstructed target. The to-be-reconstructed target may be set according to the actual application. For example, when it is needed to perform three-dimensional reconstruction on a certain object, the to-be-reconstructed target may be an object. For example, the to-be-reconstructed target may include but not limited to: a table, a chair, a sofa, etc., which are not limited here. When it is needed to perform three-dimensional reconstruction on a certain scenario, the to-be-reconstructed target may be a scenario. It should be noted that the scenario may contain several objects. Taking the to-be-reconstructed target being a living room as an example, the living room may include but is not limited to the following objects: a table, a chair, a sofa, etc. Take the to-be-reconstructed target being a building as an example, the building may include but are not limited to the following objects: stairs, corridors, gates, etc. Other situations can be deduced by analogy, and the examples will not be given here.

In an implementation scenario, in order to improve the real-time performance of the three-dimensional reconstruction, the first key image may be acquired in the process of photographing the to-be-reconstructed target. At least two frames of first key images for the current reconstruction may be acquired while photographing the to-be-reconstructed target, so as to perform incremental processing on the three-dimensional reconstruction process.

In an implementation scenario, the first key image may correspond to camera pose parameters, and the camera pose parameters may include, for example, a translation distance and a rotation angle. On this basis, the first key images meet at least one of the following: a difference of the translation distances between adjacent first key images is greater than a preset distance threshold, and a difference of the rotation angles between the adjacent first key images is greater than a preset angle threshold. The above manner can help expand the visual range of the first space as much as possible on the basis of referring to as few key images as possible in each reconstruction process, so as to improve the efficiency of three-dimensional reconstruction.

In an implementation scenario, the camera pose parameters may be acquired based on a manner such as Simultaneous Localization And Mapping (SLAM), which is not limited here. SLAM usually includes the following parts, feature extraction, data association, state estimation, state update and feature update, etc. Elaborations are omitted herein.

In another implementation scenario, for the convenience of description, the image sequence obtained by photographing the to-be-reconstructed target may be recorded as {Iₜ}, and the camera pose parameters corresponding to the image sequence may be recorded as {ξₜ}. For the camera pose parameter ξₜ, it may include the translation distance t and Rotation angle R. In order to provide a sufficient visual range in the process of maintaining the multi-view reconstruction, the first key images selected in the above image sequence need to be neither too close nor too far away from each other in the three-dimensional space. Therefore, in a case that the difference between the translation distance t of a certain frame of image in the image sequence and the translation distance t of the newly selected first key image is greater than the preset distance threshold tₘₐₓ, and the difference between the rotation angle R of the frame of image and the rotation angle R of the newly selected first key image above is greater than the preset angle threshold, the frame of image may be selected as the new first key image. In the above manner, each reconstruction process can be based on fewer first key images as much as possible, and at the same time, the visual range of the first space can be expanded as much as possible.

In yet another implementation scenario, in order to reasonably control the computational load of each three-dimensional reconstruction, the image number of at least two frames of the first key images acquired by each 3D reconstruction may be less than a preset number threshold, which may be determined according to practical applications. For example, in the case that the electronic device for performing three-dimensional reconstruction has relatively redundant computing resources, the preset number threshold may be set to be slightly larger, for example, it may be set to be 5, 10, 15, etc. In the case that the electronic device for performing three-dimensional reconstruction has relatively poor computing resources, the preset number threshold may also be set to be slightly smaller, for example, it can be set to be 2, 3, 4, etc., which is not limited here.

In addition, it should be noted that the visual cone may be understood as a entity shape with a shape of a quadrangular pyramid, and the entity shape is the shape of the area that the camera can see when rendering. It can be understood that any point in the image photographed by the camera eventually corresponds to a line in the real world, and only one point on this line will be displayed, and all objects on this line behind the displayed point will be occluded, and the outer boundary of the image is defined by the divergence lines corresponding to the four vertices, and these four lines eventually intersect at the location of the camera.

FIG. 1B is a schematic diagram of a system architecture of a method for reconstructing three-dimensional that applies to the embodiment of the present disclosure. As shown in FIG. 1B, the system architecture includes: an image capture device 2001, a network 2002, and an image acquisition terminal 2003. In order to support an exemplary application, the image capture device 2001 and the image acquisition terminal 2003 may establish a communication connection through the network 2002, the image capture device 2001 transmits the captured image to the image acquisition terminal 2003 through the network 2002, the image acquisition terminal 2003 receives the image, and processes the image to obtain the current reconstruction result.

As an example, scenario image capture device 2001 for the current scenario may include a device with an image capture function such as a camera and the like. The image acquisition terminal 2003 may include a computer device with certain computing capability and image processing capability, for example, the computer device includes a terminal device or a server or other processing device. The network 2002 may adopt wired connection manner or wireless connection manner. When the image acquisition terminal 2003 is a server, the image capture device may communicate with the image acquisition terminal through a wired connection manner, such as performing data communication through a bus. When the image acquisition terminal 2003 is a terminal device, the image acquisition device may communicate with the image acquisition terminal through a wireless connection manner, thereby performing data communication.

Optionally, in some scenarios, the image acquisition terminal 2003 may be a vision processing device with a video acquisition module, or a host computer with a camera. At this time, the information processing method of the embodiment of the present disclosure may be performed by the image acquisition terminal 2003, and the above system architecture may not include the network 2002 and the image capture device 2001.

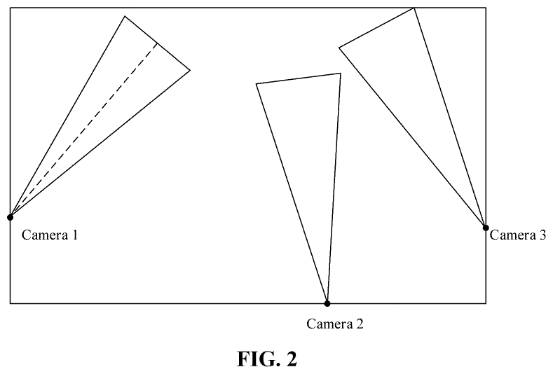

In an implementation scenario, referring to FIG. 2, FIG. 2 is a schematic diagram of an embodiment of the first space. As shown in FIG. 2, the first key images are obtained by photographing by camera 1, camera 2, and camera 3 that are indicated by black dots, respectively. In the actual application process, in order to reduce the possible interference of image information that is too far from the camera on subsequent three-dimensional reconstruction, when determining the first space, the maximum depth of the above visual cone may be pre-defined as Dₘₐₓ, that is, the height of the quadrangular pyramid is the above maximum depth Dₘₐₓ. Referring to FIG. 2 continually, for the convenience of description, the visual cone shown in the isosceles triangle in FIG. 2 is a schematic diagram of the visual cone when looking down on the first space, that is, the first space shown in FIG. 2 is a schematic diagram in a two-dimensional perspective. The dotted line in the isosceles triangle represents the above maximum depth Dₘₐₓ. In this case, it may be defined that the space surrounding the visual cones of the first key images photographed by camera 1, camera 2 and camera 3 is the first space. In order to facilitate three-dimensional reconstruction, in the embodiments of the present disclosure and the following disclosed embodiments, unless otherwise specified, the first space may include, for example, a cuboid, a cube, and other hexahedrons whose adjacent surfaces are perpendicular to each other. In addition, in the case that the visual cones of the first key images are other cases, or the number of the first key images is other case, the first space may be deduced with reference to the above description, and so on, the examples will not be given here.

In addition, in the embodiments of the present disclosure and the following disclosed embodiments, the first space may include several voxels. Taking the first space as a cuboid or a cube as an example, the voxel may also be a cuboid or a cube, and several voxels are stacked to form the first space. In addition, the size of the voxel may be set according to the actual application. For example, in the case of relatively high requirements on the accuracy of three-dimensional reconstruction, the size of voxel may be set to be slightly smaller, or, in the case of relatively loose requirements on the accuracy of three-dimensional reconstruction, the size of voxel may be set to be slightly larger, which are not limited here.

In step S12, a first feature map of the first space is obtained based on image information in the at least two frames of the first key images.

In the embodiments of the present disclosure, the first feature map includes first feature information of voxels in the first space.

In an implementation scenario, feature extraction may be performed on each frame of first key images respectively to obtain a second feature map of the first key image, and on this basis, the first feature map of the first space is obtained based on second feature information in the second feature map corresponding to each voxel of the first space. In the above manner, the second feature maps of various frames of the first key images can be fused to obtain the first feature map of the first space, which can help to improve the accuracy of the first feature map and further improve the accuracy of the three-dimensional reconstruction.

In an implementation scenario, in order to improve the efficiency of feature extraction, a three-dimensional reconstruction model may be pre-trained, and the three-dimensional reconstruction model includes a feature extraction network, so that feature extraction can be performed on each frame of the first key images based on the feature extraction network to obtain the second feature map of the first key image. Feature extraction networks may include, but are not limited to Convolutional Neural Networks (CNN), etc., which are not limited here. For the training process of the three-dimensional reconstruction model, reference may be made to the following related disclosed embodiments, which will not be described here.

In another implementation scenario, the second feature map of the first key image may be a feature map with a preset resolution, and the preset resolution may be set according to the actual application. In the case of relatively high requirements on the accuracy of three-dimensional reconstruction, the preset resolution may be set to be slightly larger, and in the case of relatively loose requirements on the accuracy of three-dimensional reconstruction, the preset resolution can be set to be slightly smaller, which is not limited here.

In yet another implementation scenario, for each voxel in the first space, the second feature information in the second feature map corresponding to the voxel may be fused to obtain the first feature information of the voxel, and finally a first feature map of the first space may be obtained on the basis of obtaining the first feature information of all voxels in the first space.

In yet another implementation scenario, in the case that the second feature information corresponding to the voxel is not extracted from the second feature map of each frame of the first key image, the preset feature information may be taken as the first feature information of the voxel. The preset feature information may be set according to the actual application. For example, in order to further reduce the computational complexity of the three-dimensional reconstruction, the preset feature information may be set to 0, which is not limited herein.

In another implementation scenario, the second feature map of each frame of the first key image may include a preset number of second feature maps corresponding to different resolutions, and the first space includes a preset number of first feature maps corresponding to different resolutions, the higher the resolution is, the smaller the size of the voxels in the first space is. The first feature map may also include a preset number of first feature maps corresponding to different resolutions, and each of the first feature maps is obtained based on second feature information of a second feature map with a same resolution. The above manner can help to the three-dimensional reconstruction by using a preset number of second feature maps of different resolutions, thereby further improving the precision of the three-dimensional reconstruction.

In an implementation scenario, the preset number may be set according to the actual application situation, for example, two different resolutions, three different resolutions, four different resolutions, etc. may be set, which is not limited herein. In addition, different resolutions may also be set according to the actual application. For example, two resolutions of 640*480 and 480*360 may be set, and two resolutions of 1280*960 and 640*480 may also be set; or, three resolutions of 640*480, 480*360 and 360*240 may be set, or, three resolutions of 1280*960, 640*480 and 480*360 may be set, which are not limited here.

In another implementation scenario, as mentioned above, in order to improve the efficiency of three-dimensional reconstruction, a three-dimensional reconstruction model may be pre-trained, and the three-dimensional reconstruction model may include a feature extraction network, and then feature extraction is performed on several first key images respectively based on the feature extraction network to obtain second feature maps with different resolutions. The feature extraction network may include, but is not limited to, Feature Pyramid Networks (FPN), which is not limited here.

In another implementation scenario, when the second feature map of the first key image includes N second feature maps corresponding to N different resolutions, the first space also includes N first spaces corresponding to N different resolutions respectively. and the higher the resolution is, the smaller the size of the voxels in the first space is. For example, when the second feature map of the first key image includes second feature maps with two resolutions of 1280*960 and 640*480, the first space also includes the first space corresponding to the resolution of 1280*960 and the first space corresponding to the resolution of 640*480. The size of the voxels in the first space corresponding to the resolution 1280*960 is smaller than the size of the voxels in the first space corresponding to the resolution 640*480. Other situations can be deduced by analogy, and the examples will not be given here. In some embodiments, for the first feature information of the voxel in the first space corresponding to the ith resolution, it may be obtained based on the corresponding second feature information in the second feature map with the ith resolution in the at least two frames of the first key images. The detailed process can refer to the following disclosed embodiments. Elaborations are omitted herein.

In yet another implementation scenario, the width of the voxel in the first space corresponding to the ith resolution may be calculated by the following formula:

$${w}_{i} = \frac{s}{{2}^{i}} \qquad ( 1 )$$

In the above formula (1), wᵢ represents the width of the voxel in the first space corresponding to the ith resolution, and s represents the preset reference voxel width, which can be adjusted according to the actual application. In addition, it should be noted that i is the ith resolution after ordering different resolutions from low to high. Still taking the above three resolutions of 1280*960, 640*480 and 480*360 as an example, after ordering from low to high, they are 480*360, 640*480, 1280*960 respectively. That is, when calculating the width of the voxel in the first space corresponding resolution 480*360, i is 1, when calculating the width of the voxel in the first space corresponding to the resolution 640*480, i is 2, and when calculating the width of the voxel in the first space corresponding to the resolution 1280*960, i is 3. Other situations can be deduced by analogy, and the examples will not be given here.

In step S13, a first reconstruction result of the current reconstruction is obtained based on the first feature map.

In an implementation scenario, prediction may be performed based on the first feature map to obtain the first reconstruction value of each voxel in the first space and the probability value of the first reconstruction value within a preset value range. The first reconstruction value is used to represent a distance between the voxel and an associated object surface in the to-be-reconstructed target. Based on this, sparsify process may be performed on the above prediction results, and the voxels whose probability values meet the preset condition in the first space may be selected, and the first reconstruction result of the current reconstruction is obtained based on first reconstruction values of the selected voxels. The above manner can filter out the interference of voxels whose probability values do not meet the preset condition on three-dimensional reconstruction, so as to further improve the accuracy of the three-dimensional reconstruction.

In an implementation scenario, in order to improve the efficiency of three-dimensional reconstruction, a three-dimensional reconstruction model can be pre-trained, and the three-dimensional reconstruction model may include a prediction network, so that the first feature map can be input into the prediction network to obtain the first reconstruction value of each voxel in the first space and the probability value of the first reconstruction value within the preset value range. The prediction network may include, but is not limited to Multi-Layer Perceptron (MLP), etc., which is not limited here.

In another implementation scenario, the first reconstruction value may be represented by a Truncated Signed Distance Function (TSDF). In this case, the preset value range may be between −1 and 1. For the convenience of description, the first reconstruction value of the jth voxel may be represented as TSDFⱼ¹. It should be noted that in the case that TSDFⱼ¹ is greater than 0 and less than 1, it represents that the jth voxel is located within the cut-off distance λ in front of the associated object surface, and in the case of TSDFⱼ¹ is less than 0 and greater than −1, it represents that the jth voxel is located within the cut-off distance λ behind the associated object surface.

In yet another implementation scenario, the probability value of the first reconstruction value within the preset value range may be regarded as the possibility of the first reconstruction value being within the preset value range, and the greater the probability value is, the higher the possibility of the first reconstruction value being within the preset value range is. Conversely, the less the probability value is, the lower the possibility of the first reconstruction value being within the preset value range is.

In yet another implementation scenario, the preset condition may be set to include that the probability value is greater than the preset probability threshold. The preset probability threshold may be set according to the actual application. For example, in the case of high requirements on the accuracy of three-dimensional reconstruction, the preset probability threshold may be set to be slightly larger, such as 0.9, 0.95, etc., or, in the case of relatively loose requirements on the accuracy of three-dimensional reconstruction, the preset probability threshold may be set to be slightly smaller, for example, it may be set to 0.8, 0.85, etc., which is not limited here.

In yet another implementation scenario, after selecting and obtaining the voxels whose probability values meet the preset condition in the first space, the selected voxels and their first reconstruction values may be taken as a first reconstruction result of the current reconstruction.

In yet another implementation scenario, in order to facilitate the subsequent reconstruction of the surface of the to-be-reconstructed target based on the reconstruction value, the associated object surface may be the object surface with the closest distance to the voxel in the to-be-reconstructed target. Taking the living room as the to-be-reconstructed target as an example, for the voxel closest to the floor in the living room, the associated object surface may be the floor, and for the voxel closest to the sofa in the living room, the associated object surface may be the sofa, and other situations can be deduced by analogy, and the examples will not be given here. The above manner can help to further improve the accuracy of the three-dimensional reconstruction.

In another implementation scenario, as mentioned above, the second feature map of each frame of the first key images may include a preset number of second feature maps corresponding to different resolutions. In this situation, one of the resolutions is selected as a current resolution successively in an order of the resolutions from low to high. On this basis, a first reconstruction result corresponding to a resolution selected in last time is upsampled. The upsampled first reconstruction result is fused with a first feature map corresponding to the current resolution to obtain a fused feature map corresponding to the current resolution. The first reconstruction result corresponding to the current resolution is obtained based on the fused feature map. In a case that the current resolution is not a highest resolution, the step of selecting one of the resolutions as the current resolution successively in the order of the resolutions from low to high and subsequent steps are re-performed. In a case that the current resolution is the highest resolution, the first reconstruction result corresponding to the current resolution is taken as the first reconstruction result of the current reconstruction. The above manner can gradually perform the three-dimensional reconstruction from the first feature map based on “low resolution” to the first feature map based on “high resolution”, so as to help to implement the three-dimensional reconstruction of “coarse to fine”, and then help to further improve the precision of three-dimensional reconstruction.

In an implementation scenario, an upsampling manner such as nearest neighbor interpolation may be used to upsample the first reconstruction result. It should be noted that, in order to facilitate the subsequent fusion of the upsampled first reconstruction result and the first feature map corresponding to the current resolution, in the case where the voxel width is calculated by the above formula (1), that is, in a case that the width of the voxel in the first space corresponding to the ith resolution is twice the width of the voxel in the first space corresponding to the i+1th resolution, the width of the upsampled voxel is half the original width, so that the width of the voxel in the upsampled first reconstruction result is the same as the width of the voxel in the first space corresponding to the current resolution.

In another implementation scenario, for each voxel, the first reconstruction value of the jth voxel in the upsampled first reconstruction result and the first feature information of the jth voxel in the first space corresponding to the current resolution may be concatenated, so as to implement the fusion of the upsampled first reconstruction result and the first feature map corresponding to the current resolution. For example, the first feature information of each voxel in the first space corresponding to the current resolution may be represented as a matrix of dimension d, and the first reconstruction value of each voxel in the upsampled first reconstruction result may be regarded as a matrix of dimension 1. Therefore, the fusion feature map obtained by concatenating the two may be regarded as a matrix of dimension d+1, and then each voxel in the fusion feature map may be represented as a matrix of dimension d+1.

In yet another implementation scenario, the detailed process of obtaining the first reconstruction result corresponding to the current resolution based on the fusion feature map can refer to the foregoing description of obtaining the first reconstruction result of the current reconstruction based on the first feature map. Elaborations are omitted herein.

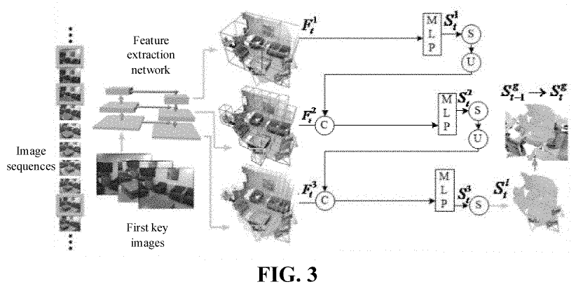

In yet another implementation scenario, referring to FIG. 3, FIG. 3 is a schematic process diagram of an embodiment of a method for reconstructing three-dimensional according to the embodiments of the present disclosure. As shown in FIG. 3, after feature extraction is performed on several first key images, which are selected from the image sequence obtained by photographing the to-be-reconstructed target, through a feature extraction network (such as the above FPN), for each frame of the first key images, three second feature maps with different resolutions are extracted, these three different resolutions may be recorded as resolution 1, resolution 2 and resolution 3 after ordering from low to high, and the first space corresponding to resolution 1 may be recorded as is the first space 1, the first space corresponding to the resolution 2 may be recorded as the first space 2, and the first space corresponding to the resolution 3 may be recorded as the first space 3. For each of the resolutions, the first feature map of the first space corresponding to this resolution may be obtained based on the second feature information, in the second feature map of this resolution, corresponding to each voxel of the first space corresponding to this resolution. For the convenience of description, the first feature map of the first space 1 of the current reconstruction (i.e., the t-th time step) may be recorded as Fₜ¹, the first feature map of the first space 2 may be recorded as Fₜ², and the first feature map of the first space 3 may be recorded as Fₜ³. According to the order of resolution from low to high, firstly, resolution 1 is selected as the current resolution, and the first reconstruction result corresponding to a resolution selected in last time is upsampled. Since resolution 1 is the resolution selected firstly, there is no first reconstruction result corresponding to the resolution selected in last time, so that prediction may be directly performed on the first feature map Fₜ¹ corresponding to the current resolution based on a prediction network such as MLP, to obtain the first reconstruction value of each voxel in the first space 1 and the probability value of the first reconstruction value within the preset value range. For convenience of description, the first reconstruction value of each voxel in the first space 1 may be recorded as Sₜ¹, and then sparsify process is performed on Sₜ¹ to obtain the first reconstruction result (i.e., S in FIG. 3). Since the current resolution is not the highest resolution, the resolution 2 may then be taken as the current resolution, and the first reconstruction result corresponding to the resolution 1 selected in the last time is upsampled (i.e., U in FIG. 3), and concatenating process is performed on the upsampled first reconstruction result with the first feature map Fₜ² corresponding to the current resolution (i.e., C in FIG. 3), and the fusion feature map corresponding to resolution 2 is obtained, so that prediction is performed on fusion feature map based on prediction networks such as MLP to obtain the first reconstruction value of each voxel in the first space 2 and the probability value of the first reconstruction value within the preset value range. For convenience of description, the first reconstruction value of each voxel in the first space 2 may be recorded as Sₜ², then sparsify process is performed on Sₜ² to obtain the first reconstruction result (i.e., S in FIG. 3). Since the current resolution is still not the highest resolution, resolution 3 may then be taken as the current resolution, and the first reconstruction result corresponding to the resolution 2 selected in last time is upsampled (i.e., U in FIG. 3), and concatenating process is performed based on the upsampled first reconstruction result and the first feature map Fₜ³ corresponding to the current resolution (i.e., C in FIG. 3) to obtain the fusion feature map corresponding to resolution 3, so that prediction is performed on fusion feature map based on prediction networks such as MLP to obtain the first reconstruction value of each voxel in the first space 3 and the probability value of the first reconstruction value within the preset value range. For convenience of description, the first reconstruction value of each voxel in the first space 3 may be recorded as Sₜ³, then sparsify process is performed on Sₜ³ to obtain the first reconstruction result (i.e., S in FIG. 3). Since the current resolution is the highest resolution, the first reconstruction result corresponding to the current resolution may be taken as the final first reconstruction result of the current reconstruction. For convenience of description, the final first reconstruction result of the current reconstruction may be recorded as Sₜ¹. Other situations can be deduced by analogy, and the examples will not be given here.

In step S14, a second reconstruction result obtained by previous reconstruction is updated based on the first reconstruction result of the current reconstruction.

In an implementation scenario, as described above, the first reconstruction result includes, for example, the first reconstruction value of the voxel in the first space. Similarly, the second reconstruction result includes the second reconstruction value of the voxel in the second space. The second space is the total space surrounding the visual cones of the previously reconstructed second key images, and the first reconstruction value and the second reconstruction value are used to represent the distances between the voxels and the associated object surfaces in the to-be-reconstructed target. For example, reference may be made to the above related description about the first reconstruction value. Elaborations are omitted herein. On this basis, the second reconstruction value of the corresponding voxel in the second space may be updated based on the first reconstruction value of the voxel in the first space. The above manner can help to update the second reconstruction result obtained by the previous reconstruction based on the first reconstruction value of voxel in the first space of the current reconstruction in the three-dimensional reconstruction process, so as to continuously improve the second reconstruction result in the reconstruction process and improve the accuracy of three-dimensional reconstruction.

In one implementation scenario, when the current reconstruction is the first time of reconstruction in the three-dimensional reconstruction process of the to-be-reconstructed target, the step of updating the second reconstruction result obtained by the previous reconstruction based on the first reconstruction result of the current reconstruction may not be performed.

In another implementation scenario, the second reconstruction value of the voxels of the part of the second space corresponding to the first space may be replaced with the first reconstruction value of the voxels in the first space of the current reconstruction. Referring to FIG. 3 continuously, as mentioned above, for the convenience of description, the final first reconstruction result of the current reconstruction is recorded as Sₜ¹, the second reconstruction result obtained by the previous reconstruction may be recorded as Sₜ₋₁^{g}. The second reconstruction value of the corresponding voxel in the second space is updated based on the first reconstruction value of voxel in the first space, so that the updated second reconstruction result may be obtained, for the convenience of description, which may be recorded as Sₜ^{g}.

In yet another implementation scenario, in the case that further reconstruction is required after the current reconstruction, the above step S11 and subsequent steps may be re-performed to continuously improve the second reconstruction result through multiple reconstructions. In addition, in the case that no further reconstruction is required after the current reconstruction, the updated second reconstruction result Sₜ^{g} may be taken as the final reconstruction result of the to-be-reconstructed target.

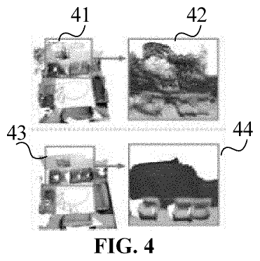

In another implementation scenario, referring to FIG. 4, FIG. 4 is a schematic diagram of the effects of a method for reconstructing three-dimensional according to the embodiments of the present disclosure and other method for reconstructing three-dimensional. The 41 and 42 in FIG. 4 represent reconstruction results obtained by other reconstruction methods, and the 43 and 44 in FIG. 4 represent reconstruction results obtained by the three-dimensional reconstruction method according to the embodiments of the present disclosure. As shown in 41 and 42 in FIG. 4, obvious dispersion and delamination phenomenon in the wall part circled by the rectangular frame are appeared in the reconstruction results obtained by other three-dimensional reconstruction methods, while in 43 and 44 in FIG. 4, the reconstruction results obtained by the three-dimensional reconstruction method according to the embodiments of the present disclosure do not show obvious dispersion or delamination phenomenon in the wall part circled by the rectangular frame, and have better smoothness.

In the above solution, by acquiring at least two frames of first key images for current reconstruction, determining a first space surrounding visual cones of the at least two frames of the first key images, the first key images being obtained by photographing a to-be-reconstructed target, then based on this, obtaining a first feature map of the first space based on image information in the at least two frames of the first key images, the first feature map including first feature information of voxels in the first space, a first reconstruction result of the current reconstruction is obtained based on the first feature map, and then a second reconstruction result obtained by previous reconstruction is updated based on the first reconstruction result of the current reconstruction. Therefore, in each reconstruction process, the whole first space surrounding the visual cones of the at least two frames of the first key image can be reconstructed in three dimensions, which can not only greatly reduce the computational load, but also reduce the probability of occurring stratification or dispersion of reconstruction results, so as to improve the real-time performance of three-dimensional reconstruction process and the smoothness of three-dimensional reconstruction results.

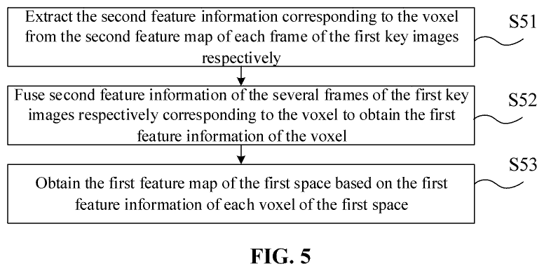

Referring to FIG. 5, FIG. 5 is a schematic flowchart of an embodiment of step S12 in FIG. 1A. As described in the above disclosed embodiments, feature extraction may be performed on each frame of the first key images respectively to obtain the second feature map of the first key images, so that the first feature map of the first space is obtained based on second feature information in the second feature map corresponding to each voxel of the first space. In the schematic flowchart of obtaining the first feature map of the first space based on the second feature information in the second feature map corresponding to each voxel in the embodiments of the present disclosure, the following steps are included.

In step S51, the second feature information corresponding to the voxel is extracted from the second feature map of each frame of the first key images respectively.

In the embodiments of the present disclosure, for each voxel in the first space, the second feature information corresponding to the voxel may be extracted from the second feature map of each frame of the first key images respectively.

In an implementation scenario, each pixel in the second feature map may be back-projected based on the camera pose parameters of the first key image and the camera internal parameters to determine the voxels in the first space corresponding to the pixels in the second feature map. Based on this, for each voxel in the first space, the second feature information of the pixel corresponding to the voxel can be extracted from the second feature map of each frame of the first key images.

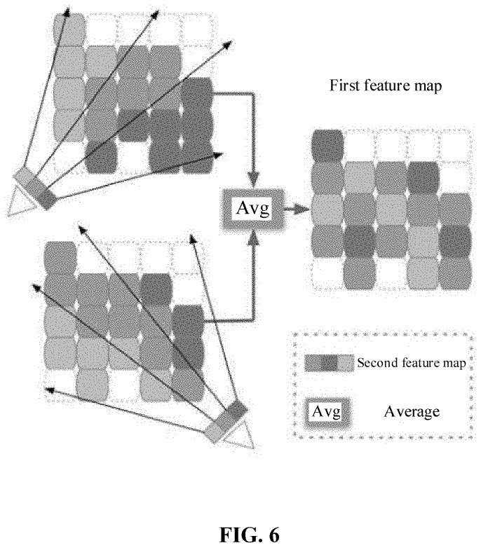

In another implementation scenario, referring to FIG. 6, FIG. 6 is a state schematic diagram of an embodiment of acquiring the first feature map. As shown in FIG. 6, for the convenience of description, similar to FIG. 2, FIG. 6 also describes the detailed process of acquiring the first feature map from a “two-dimensional perspective”. As shown in FIG. 6, by back-projecting the pixels in the second feature map, the voxels corresponding to each pixel in the first space can be determined. It should be noted that the squares of different colors in FIG. 6 represent corresponding to different second feature information.

In Step S52, second feature information of the at least two frames of the first key images respectively corresponding to the voxel is fused to obtain the first feature information of the voxel.

In an implementation scenario, referring to FIG. 6 continuously, an average value of the second feature information of the at least two frames of the first key images respectively corresponding to the voxel is taken as the first feature information of the voxel. For example, for the k-th voxel in the first space, it corresponds to the pixel at ith row and jth column in the second feature map of the first first-key image, and corresponds to the pixel at mth row and nth column in the second feature map of the second first-key image. On this basis, the average value of the second feature information of the pixel at the ith row and the jth column in the second feature map of the first first-key image and the second feature information of the pixel at the mth row and the nth column in the second feature map of the second first-key image is taken as the first feature information of the kth voxel in the first space. Other situations can be deduced by analogy, and the examples will not be given here.

In another implementation scenario, the weighted result of the second feature information of the at least two frames of the first key images respectively corresponding to the voxel may be taken as the first feature information of the voxel. The above weighted result may include, but are not limited to, weighted summation, weighted average, etc., which are not limited herein.

In yet another implementation scenario, as described in the above disclosed embodiments, preset feature information is taken as the first feature information of the voxel in a case that second feature information corresponding to the voxel is not extracted from the second feature map of each frame of the first key images. Reference may be made to the relevant descriptions in the above disclosed embodiments. Elaborations are omitted herein

In step S53, the first feature map of the first space is obtained based on the first feature information of each voxel of the first space.

After obtaining the first feature information of each pixel in the first space, the entire first feature information of various voxels in the first space may be used as the first feature map.

Different from the above embodiments, by extracting the second feature information corresponding to the voxel from the second feature map of each frame of the first key images respectively, and fusing second feature information of the at least two frames of the first key images respectively corresponding to the voxel to obtain the first feature information of the voxel, the first feature map of the first space is obtained based on the first feature information of each voxel of the first space. Therefore, for each voxel in the first space, the second feature information corresponding to each frame of the first key images is fused, which can further improve the accuracy of the first feature map of the first space.

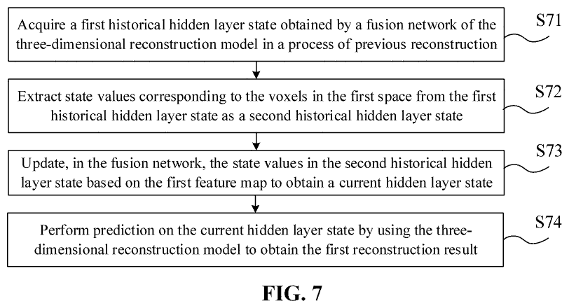

Referring to FIG. 7, FIG. 7 is a schematic flowchart of an embodiment of step S13 in FIG. 1A. In the embodiment of the present disclosure, the first reconstruction result is obtained by using a three-dimensional reconstruction model. the following steps are included.

In step S71, the first historical hidden layer state obtained by a fusion network of the three-dimensional reconstruction model in a process of previous reconstruction is acquired.

The embodiments of the present disclosure, the first historical hidden layer state includes state values corresponding to voxels in the second space, and the second space is the total space surrounding the visual cones of previously reconstructed second key images. It should be noted that, in the case that the current reconstruction is the first time of reconstruction, the second space is the first space of the current reconstruction, and in this case, the state value corresponding to the voxel in the second space included in the first historical hidden layer state may be set to the preset state value (e.g., the preset state value is set to 0).

In step S72, state values corresponding to the voxels in the first space are extracted from the first historical hidden layer state as the second historical hidden layer state.

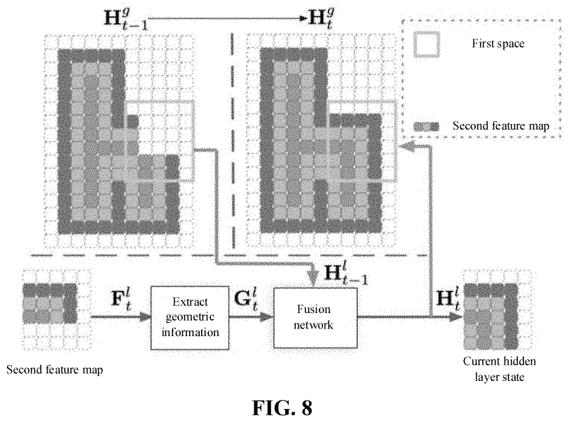

Referring to FIG. 8, FIG. 8 is a state schematic diagram of an embodiment of acquiring the current hidden layer state. It should be noted that, for the convenience of description, similar to the above FIG. 2 and FIG. 6, FIG. 8 is a state schematic diagram of acquiring the current hidden layer state described in the “two-dimensional perspective”. As shown in FIG. 8, for the convenience of description, the first historical hidden layer state may be recorded as Hₜ₋₁^{g}, the squares of different grayscales in the first historical hidden layer state Hₜ₋₁^{g} represent the state values of the voxels, and the uncolored squares represent that the corresponding voxels have no state value. In addition, the rectangular box in the first historical hidden layer state Hₜ₋₁^{g} represents the first space, and the second historical hidden layer state Hₜ₋₁^{g} may be obtained by extracting the state values corresponding to the voxels of the first space from the first historical hidden layer state Hₜ₋₁^{g}. Other situations can be deduced by analogy, and the examples will not be given here.

In step S73, the following operation is performed based on the fusion network, the state values in the second historical hidden layer state are updated based on the first feature map to obtain a current hidden layer state.

In an implementation scenario, the first feature map and the second historical hidden layer state may be input into the fusion network, so as to output the current hidden layer state. The fusion network may be set to include but not limited to Gated Recurrent Unit (GRU), which is not limited here.

In another implementation scenario, further referring to FIG. 8, before updating the second historical hidden layer state Hₜ₋₁^{l}, the geometric information of the first feature map Fₜ^{l} may be further extracted to obtain a geometric feature map Gₜ^{l}, and the geometric feature map includes the geometric information of the voxels, so that the state values in the second historical hidden layer state may be updated based on the geometric feature map to obtain the current hidden layer state. The above manner can update the second historical hidden layer state of the first space of the current reconstruction on the basis of the geometric information of voxels obtained by extracting, so as to help to improve the accuracy of three-dimensional reconstruction.

In an implementation scenario, geometric information may be extracted from the first feature map through networks, such as three-dimensional sparse convolution, pointnet, etc., to obtain a geometric feature map Gₜ^{l}, which may be set according to actual application need, which is not limited here.

In another implementation scenario, taking the fusion network including the GRU as an example, referring to FIG. 8, the GRU can finally obtain the current hidden layer state Hₜ^{l} by fusing the geometric feature map Gₜ^{l} and the second historical hidden layer state Hₜ₋₁^{l}. For the convenience of description, the update gate of the GRU may be recorded as zₜ, and the reset gate may be rₜ. They may be represented as:

zₜ=σ(sparseconv([Hₜ₋₁^{l},Gₜ^{l}],w_{z})) (2)

rₜ=σ(sparseconv([Hₜ₋₁^{l},Gₜ^{l}],wᵣ)) (3)

In the above formula (2) and formula (3), sparseconv represents the sparse convolution, W_{z} and Wᵣ represent the network weights of the sparse convolution, and a represents the activation function (e.g., sigmoid).

Based on this, the update gate zₜ and reset gate rₜ may decide how much information is introduced from the geometric feature map Gₜ^{l} for fusion, and how much information is introduced from the second historical hidden layer state Hₜ₋₁^{l} for fusion. It may be represented as:

\tilde{H}ₜ^{l}=tanh(sparseconv([rₜ⊙Hₜ₋₁^{l},Gₜ^{l}],wₕ)) (4)

Hₜ^{l}=(1−zₜ)⊙Hₜ₋₁^{l}+zₜ⊙\tilde{H}ₜ^{l} (5)

In the above formula (4) and formula (5), sparseconv represents the sparse convolution, Wℏ represents the network weight of the sparse convolution, and tanh represents the activation function. It can be seen that, as a data-driven manner, GRU can provide a selective attention mechanism in the three-dimensional reconstruction process.

In step S74, prediction is performed on the current hidden layer state by using the three-dimensional reconstruction model to obtain the first reconstruction result.

In an implementation scenario, as described in the above disclosed embodiments, the three-dimensional model may further include a prediction network (e.g., MLP). Based on this, prediction may be performed on the current hidden layer state Hₜ^{l} based on the prediction network to obtain the first reconstruction result.

In an implementation scenario, by performing prediction on the current hidden layer state Hₜ^{l} based on the prediction network, the first reconstruction value of each voxel in the first space and the probability value of the first reconstruction value within a preset value range may be obtained. The first reconstruction value is used to represent the distance between the voxel and the associated object surface in the to-be-reconstructed target. Based on this, the voxels whose probability values meet the preset condition in the first space may be selected, so that the first reconstruction value of the current reconstruction is obtained based on first reconstruction values of the selected voxels. For details, reference may be made to the relevant descriptions in the above disclosed embodiments. Elaborations are omitted herein.

In another implementation scenario, continuously referring to FIG. 8, after obtaining the current hidden layer state Hₜ^{l}, the state values of the corresponding voxels in the first historical hidden layer state Hₜ₋₁^{g} may be updated based on the state values in the current hidden layer state Hₜ^{l}, to obtain the updated first historical hidden layer state Hₜ^{g}, which is used for the next time of reconstruction. By the above manner, the first historical hidden layer state of the second space is further updated after obtaining the current hidden layer state by updating, which can help to further improve the accuracy of the first historical hidden layer state of the second space on the basis of the current reconstruction, so as to help to improve the accuracy of three-dimensional reconstruction.

In one implementation scenario, the state values of the voxels in the first space in the first historical hidden layer state Hₜ₋₁^{g} may be directly replaced with the state values of the corresponding voxels in the current hidden layer state Hₜ^{l}.

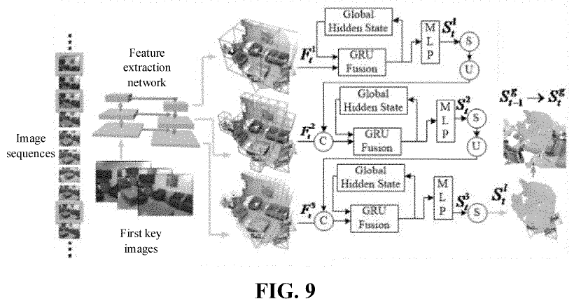

In yet another implementation scenario, referring to FIG. 9, FIG. 9 is a schematic process diagram of another embodiment of a method for reconstructing three-dimensional according to the embodiments of the present disclosure. Different from the three-dimensional reconstruction process shown in FIG. 3, as described in the embodiments of the present disclosure, the three-dimensional reconstruction process shown in FIG. 9 introduces the first historical hidden layer state (i.e., the global hidden state in FIG. 9) obtained by the previous reconstruction. That is, in the three-dimensional reconstruction process described in the above disclosed embodiments, each time of the prediction for the first feature map Fₜⁱ corresponding to the current resolution based on a prediction network such as MLP may include the following steps. The first historical hidden layer state corresponding to the current resolution obtained by previous reconstruction is acquired, and the state values corresponding to the voxels in the first space are extracted from the first historical hidden layer state corresponding to the current resolution to be taken as the second historical hidden layer state, and the following operation is performed based on fusion network such as GRU. The state values in the second historical hidden layer state is updated based on the first feature map Fₜⁱ corresponding to the current resolution to obtain the current hidden layer state corresponding to the current resolution. Based on this, prediction is performed on the current hidden layer state corresponding to the current resolution based on the prediction network such as MLP, etc., to obtain the first reconstruction result corresponding to the current resolution. Only the differences between the embodiment of the present disclosure and the above disclosed embodiments are described, and other processes may be referenced to the relevant descriptions in the above disclosed embodiments. Elaborations are omitted herein.

Different from the above embodiments, by setting the first reconstruction result to be obtained by using a three-dimensional reconstruction model, acquiring a first historical hidden layer state obtained by a fusion network of the three-dimensional reconstruction model in a process of previous reconstruction, the first historical hidden layer state including state values corresponding to voxels in a second space, and the second space being a total space surrounding visual cones of previously reconstructed second key images, based on this, state values corresponding to the voxels in the first space are extracted from the first historical hidden layer state as a second historical hidden layer state, thereby performing the following operations based on the fusion network. The state values in the second historical hidden layer state is updated based on the first feature map to obtain a current hidden layer state, and prediction is performed on the current hidden layer state by using the three-dimensional reconstruction model to obtain the first reconstruction result, so that each reconstruction process can refer to the first historical hidden layer state obtained by the previous reconstruction, which can help to improve the consistency between the current reconstruction and the previous reconstruction, so as to reduce the probability of stratification or dispersion between the current reconstruction results and the previous reconstruction results, and further improve the smoothness of the three-dimensional reconstruction results.

In some disclosed embodiments, the three-dimensional reconstruction result in any of the above method embodiments for reconstructing three-dimensional may be obtained by reconstructing through a three-dimensional reconstruction model. Several groups of sample images photographed on the sample target may be pre-collected, each group of sample images includes at least two frames of sample key images, and the visual cones of at least two frames of sample key images included in each group of sample images are surrounded by the first sample space. The first sample space includes several voxels, and reference may be made to the relevant descriptions in the above disclosed embodiments, and elaborations are omitted herein. Different from the above disclosed embodiments, each group of sample images is marked with the first actual reconstruction value of each voxel in the first sample space and the actual probability value of the first actual reconstruction value within a preset value range, and the first actual reconstruction value is used to represent the distance between the voxel and the associated object surface in the sample target. The first actual reconstruction value may be represented by TSDF, and the associated object surface may refer to the relevant description in the above disclosed embodiments. Elaborations are omitted herein. In addition, in the case where the first actual reconstruction value is within the preset value range, the actual probability value corresponding to the first actual reconstruction value may be marked as 1, and in the case where the first actual reconstruction value is not within the preset value range, the actual probability value corresponding to the first actual reconstruction value may be marked as 0. On this basis, at least two frames of sample key images included in a group of sample images may be input into the feature extraction network (e.g., FPN) of the three-dimensional reconstruction model to obtain the first sample feature map of the first sample space. A sample feature map includes the first sample feature information of the voxels in the first sample space, so that the first sample feature map may be input into the prediction network of the three-dimensional reconstruction model to obtain the first sample reconstruction result. The sample reconstruction result includes the first sample reconstruction value of each voxel in the first sample space and the sample probability value of the first sample reconstruction value within the preset value range, and the network parameters of the three-dimensional reconstruction model are further adjusted based on the difference between the first sample reconstruction value and the first actual reconstruction value of each voxel in the first sample space, and the difference between the sample probability value and the actual probability value of each voxel in the first sample space.

In one implementation scenario, the first loss value between the sample probability value and the actual probability value may be calculated based on a binary cross-entropy (BCE) loss function, and the second loss value between the first sample reconstruction value and the first actual reconstruction value may be calculated based on L1 loss function, so that the network parameters of the three-dimensional reconstruction model may be adjusted based on the first loss value and the second loss value.

In another implementation scenario, similar to the above disclosed embodiments, in the process of predicting the first sample reconstruction result, the first sample historical hidden layer state obtained in the previous reconstruction by the fusion network of the three-dimensional reconstruction model may be acquired, and the first sample historical hidden layer state includes the sample state values corresponding to the voxels in the second sample space, and the second sample space is the total space surrounding the visual cones of previously reconstructed several groups of sample images. The sample state values corresponding to the voxels of the first sample space are extracted from the first sample historical hidden layer state to be taken as the second sample historical hidden layer state, so that the following operation is performed based on the fusion network. The sample state values in the second sample historical hidden layer state are updated based on the first sample feature map to obtain the current sample hidden layer state, and then the current sample hidden layer state may be predicted based on the prediction network to obtain the first sample reconstruction result. Reference may be made to the relevant descriptions in the foregoing disclosed embodiments. Elaborations are omitted herein.

The embodiments of the present disclosure provide a method for reconstructing three-dimensional. The method includes the following operations. At least two frames of first key images for current reconstruction are acquired. A first space surrounding visual cones of the at least two frames of the first key images is determined. The first key images are obtained by photographing a to-be-reconstructed target. A first feature map of the first space is obtained based on image information in the at least two frames of the first key images. The first feature map includes first feature information of voxels in the first space. A first reconstruction result of the current reconstruction is obtained based on the first feature map. A second reconstruction result obtained by previous reconstruction is updated based on the first reconstruction result of the current reconstruction.

Accordingly, at least two frames of first key images for current reconstruction are acquired, a first space surrounding visual cones of the at least two frames of the first key images is determined, and the first key images are obtained by photographing a to-be-reconstructed target. Then, a first feature map of the first space is obtained on the basis of image information in the at least two frames of the first key images, the first feature map including first feature information of voxels in the first space, a first reconstruction result of the current reconstruction is obtained based on the first feature map, and then a second reconstruction result obtained by previous reconstruction is updated based on the first reconstruction result of the current reconstruction. Therefore, in each reconstruction process, three-dimensional reconstruction can be performed on the whole first space surrounding the visual cones of the at least two frames of the first key image, which can not only greatly reduce the computational load, but also reduce the probability of occurring stratification or dispersion of reconstruction results, so as to improve the real-time performance of three-dimensional reconstruction process and the smoothness of three-dimensional reconstruction results.

After acquiring the at least two frames of the first key images for the current reconstruction, the method further includes the following operation. Feature extraction is performed on each frame of the first key images respectively to obtain second feature maps of the first key images. The operation of obtaining the first feature map of the first space based on the image information in the at least two frames of the first key images includes the following operation. The first feature map of the first space is determined based on second feature information in the second feature map corresponding to each voxel of the first space.

Therefore, by performing feature extraction on each frame of the first key images respectively to obtain a second feature map of each frame of the first key images, the first feature map of the first space is determined based on second feature information in the second feature map corresponding to various voxels of the first space. Therefore, the second feature maps of various frames of the first key images can be fused to obtain the first feature map of the first space, which is conducive to improving the accuracy of the first feature map and then the accuracy of three-dimensional reconstruction.

The operation of obtaining the first feature map of the first space based on the second feature information in the second feature map corresponding to each voxel in the first space includes the following operations. The second feature information corresponding to the voxel is extracted from the second feature map of each frame of the first key images respectively. Second feature information of the at least two frames of the first key images respectively corresponding to the voxel are fused to obtain the first feature information of the voxel. The first feature map of the first space is obtained based on the first feature information of each voxel of the first space.

Therefore, by extracting the second feature information corresponding to the voxel from the second feature map of each frame of the first key images respectively, and fusing second feature information of the at least two frames of the first key images respectively corresponding to the voxel to obtain the first feature information of the voxel, the first feature map of the first space is obtained based on the first feature information of each voxel of the first space. Therefore, for each voxel in the first space, the second feature information corresponding to each frame of the first key images is fused, which can further improve the accuracy of the first feature map of the first space.

The operation of fusing second feature information of the at least two frames of the first key images respectively corresponding to the voxel to obtain the first feature information of the voxel includes at least one of the following the operations. An average value of the second feature information of various frames of the first key images respectively corresponding to the voxel is taken as the first feature information of the voxel. Preset feature information is taken as the first feature information of the voxel in a case that second feature information corresponding to the voxel is not extracted from the second feature map of each frame of the first key images.

Therefore, by taking an average value of the second feature information of various frames of the first key images respectively corresponding to the voxel as the first feature information of the voxel, the complexity of obtaining the first feature information can be reduced, which can help to improve the speed of three-dimensional reconstruction, and then further improve the real-time performance of three-dimensional reconstruction process. Preset feature information is taken as the first feature information of the voxel in a case that second feature information corresponding to the voxel is not extracted from the second feature map of each frame of the first key images, which can further help to reduce complexity of obtaining the first feature information.

The second feature map of each frame of the first key images includes a preset number of second feature maps corresponding to different resolutions. The first space includes a preset number of first spaces corresponding to the different resolutions. The higher the resolution is, the smaller the size of voxels in the first space is. The first feature map includes a preset number of first feature maps corresponding to the different resolutions, and each of the first feature maps is obtained based on second feature information of a second feature map with a same resolution.

Therefore, the second feature map of each frame of the first key images is set to include a preset number of second feature maps corresponding to different resolutions, and the first space includes a preset number of first spaces corresponding to the different resolutions. The higher the resolution is, the smaller the size of voxels in the first space is. In addition, the first feature map is set to include a preset number of first feature maps corresponding to the different resolutions, and each of the first feature maps is obtained based on second feature information of a second feature map with a same resolution, which can facilitate the three-dimensional reconstruction through the preset number of second feature images with different resolutions, so as to further improve the precision of three-dimensional reconstruction.

The operation of determining the first reconstruction result of the current reconstruction based on the first feature map includes the following operations. One of the resolutions is selected as a current resolution successively in an order of the resolutions from low to high. A first reconstruction result corresponding to a resolution selected in last time is upsampled. The upsampled first reconstruction result is fused with a first feature map corresponding to the current resolution to obtain a fused feature map corresponding to the current resolution. A first reconstruction result corresponding to the current resolution is obtained based on the fused feature map. In a case that the current resolution is not a highest resolution, the step of selecting one of the resolutions as the current resolution successively in the order of the resolutions from low to high and subsequent steps are re-performed. The first reconstruction result corresponding to the current resolution is taken as the final first reconstruction result of the current reconstruction in a case that the current resolution is the highest resolution.

Therefore, by selecting one of the resolutions as a current resolution successively in an order of the resolutions from low to high, upsampling a first reconstruction result corresponding to a resolution selected in last time, and fusing the upsampled first reconstruction result with a first feature map corresponding to the current resolution to obtain a fused feature map corresponding to the current resolution, obtaining, based on the fused feature map, a first reconstruction result corresponding to the current resolution, in a case that the current resolution is not a highest resolution, the step of selecting one of the resolutions as the current resolution successively in the order of the resolutions from low to high and subsequent steps are re-performed, or in a case that the current resolution is the highest resolution, the first reconstruction result corresponding to the current resolution is taken as the first reconstruction result of the current reconstruction, which can gradually perform the three-dimensional reconstruction from the first feature map based on “low resolution” to the first feature map based on “high resolution”, so as to help to achieve the three-dimensional reconstruction of “coarse to fine”, and then help to further improve the precision of three-dimensional reconstruction.

The operation of determining the first reconstruction result of the current reconstruction based on the first feature map includes the following operations. Prediction is performed based on the first feature map to obtain a first reconstruction value of each voxel in the first space and a probability value of the first reconstruction value within a preset value range. The first reconstruction value is used to represent a distance between the voxel and an associated object surface in the to-be-reconstructed target. Voxels whose probability values meet a preset condition in the first space are selected. The first reconstruction result of the current reconstruction is obtained based on first reconstruction values of the selected voxels.

Therefore, by performing prediction based on the first feature map to obtain a first reconstruction value of each voxel in the first space and a probability value of the first reconstruction value within a preset value range, the first reconstruction value being used to represent a distance between the voxel and an associated object surface in the to-be-reconstructed target, selecting voxels whose probability values meet a preset condition in the first space, and obtaining the first reconstruction result of the current reconstruction based on first reconstruction values of the selected voxels, which can filter out the interference of voxels, whose probability values do not meet the preset condition, on three-dimensional reconstruction, so as to further improve the accuracy of three-dimensional reconstruction.

The first reconstruction result includes first reconstruction values of the voxels in the first space, the second reconstruction result includes second reconstruction values of the voxels in a second space, the second space is a total space surrounding visual cones of previously reconstructed second key images, and the first reconstruction value and the second reconstruction value are used to represent distances between the voxels and associated object surfaces in the to-be-reconstructed target. The operation of updating, based on the first reconstruction result of the current reconstruction, the second reconstruction result obtained by previous reconstruction includes the following operation. The second reconstruction values corresponding to the voxels in the second space is updated based on the first reconstruction values of the voxels in the first space.

Therefore, the first reconstruction result is set to include first reconstruction values of the voxels in the first space, the second reconstruction result is set to include second reconstruction values of the voxels in a second space, the second space is a total space surrounding visual cones of previously reconstructed second key images, and the first reconstruction value and the second reconstruction value are used to represent distances between the voxels and associated object surfaces in the to-be-reconstructed target. On this basis, the second reconstruction values corresponding to the voxels in the second space is updated based on the first reconstruction values of the voxels in the first space, which can help to update the second reconstruction result obtained by the previous reconstruction based on the first reconstruction value of voxels in the first space of the current reconstruction in the three-dimensional reconstruction process, so as to continuously improve the second reconstruction result in the reconstruction process and improve the accuracy of three-dimensional reconstruction.

The associated object surface is an object surface closest to the voxel in the to-be-reconstructed target.

Therefore, the associated object surface is set to be an object surface closest to the voxel in the to-be-reconstructed target, which can help to further improve the accuracy of three-dimensional reconstruction.

The first reconstruction result is obtained by using a three-dimensional reconstruction model. The operation of determining the first reconstruction result of the current reconstruction based on the first feature map includes the following operations. A first historical hidden layer state obtained by a fusion network of the three-dimensional reconstruction model in a process of previous reconstruction is acquired. The first historical hidden layer state includes state values corresponding to voxels in a second space. the second space is a total space surrounding visual cones of previously reconstructed second key images. State values corresponding to the voxels in the first space is extracted from the first historical hidden layer state as a second historical hidden layer state. In the fusion network, the state values in the second historical hidden layer state is updated based on the first feature map to obtain a current hidden layer state. Prediction is performed on the current hidden layer state by using the three-dimensional reconstruction model to obtain the first reconstruction result.

Therefore, by setting the first reconstruction result to be obtained by using a three-dimensional reconstruction model, acquiring a first historical hidden layer state obtained by a fusion network of the three-dimensional reconstruction model in a process of previous reconstruction, the first historical hidden layer state including state values corresponding to voxels in a second space, and the second space being a total space surrounding visual cones of previously reconstructed second key images, on this basis, extracting state values corresponding to the voxels in the first space from the first historical hidden layer state as a second historical hidden layer state, then based on the fusion network, the state values in the second historical hidden layer state is updated based on the first feature map to obtain a current hidden layer state, and prediction is performed on the current hidden layer state by using the three-dimensional reconstruction model to obtain the first reconstruction result, so that each reconstruction process can refer to the first historical hidden layer state obtained by the previous reconstruction, which can help to improve the consistency between the current reconstruction and the previous reconstruction, so as to reduce the probability of stratification or dispersion between the current reconstruction results and the previous reconstruction results, and further improve the smoothness of the three-dimensional reconstruction results.

When the current reconstruction is a first time of reconstruction, the state values in the first historical hidden layer state are preset state values.

Therefore, when the current reconstruction is a first time of reconstruction, the state values in the first historical hidden layer state are set to be preset state values, which helps to improve the robustness of three-dimensional reconstruction.

The fusion network includes: a Gated Recurrent Unit, the three-dimensional reconstruction model further includes a prediction network. The operation of performing prediction on the current hidden layer state by using the three-dimensional reconstruction model to obtain the first reconstruction result includes the following operation. Prediction is performed on the current hidden layer state based on the prediction network to obtain the first reconstruction result.

Therefore, the fusion network is set to include a Gated Recurrent Unit, which can help to introduce the selective attention mechanism through the Gated Recurrent Unit, so as to selectively refer to the first historical hidden layer state obtained by previous reconstruction in the process of three-dimensional reconstruction, thereby improving the accuracy of three-dimensional reconstruction. The three-dimensional reconstruction model is set to include the prediction network, then prediction is performed on the current hidden layer state based on the prediction network to obtain the first reconstruction result, which can help to improve the efficiency of three-dimensional reconstruction.

Before updating the state values in the second historical hidden layer state based on the first feature map to obtain the current hidden layer state, the method further includes the following operation. Geometric information is extracted from the first feature map to obtain a geometric feature map. The geometric feature map includes geometric information of the voxels. The operation of updating the state values in the second historical hidden layer state based on the first feature map to obtain the current hidden layer state includes the following operation. The state values in the second historical hidden layer state is updated based on the geometric feature map to obtain the current hidden layer state.

Therefore, a geometric feature map is obtained by extracting geometric information from the first feature map, the geometric feature map including geometric information of the voxels. Based on this, the state values in the second historical hidden layer state are updated based on the geometric feature map to obtain the current hidden layer state, which can update the second historical hidden layer state of the first space of the current reconstruction on the basis of the geometric information of voxels obtained by perform extracting, so as to help to improve the accuracy of three-dimensional reconstruction.

After updating the state values in the second historical hidden layer state based on the first feature map to obtain the current hidden layer state, the method further includes the following operation. State values of corresponding voxels in the first historical hidden layer state are updated correspondingly based on state values in the current hidden layer state.

Therefore, state values of corresponding voxels in the second historical hidden layer state of the currently reconstructed first space are updated based on state values in the current hidden layer state. After the current hidden layer state is obtained by updating, the first historical hidden layer state of the second space is further updated, which is conducive to further improve the accuracy of the first historical hidden layer state of the second space on the basis of the current reconstruction, so as to improve the accuracy of three-dimensional reconstruction.

The at least two frames of the first key images is acquired in a process of photographing the to-be-reconstructed target. The first key images correspond to camera pose parameters, the camera pose parameters include a translation distance and a rotation angle, and the first key images meet at least one of the following: a difference of the translation distances between adjacent first key images is greater than a preset distance threshold, and a difference of the rotation angles between the adjacent first key images is greater than a preset angle threshold.

Therefore, the at least two frames of the first key images is set to be acquired in a process of photographing the to-be-reconstructed target, which can implement three-dimensional reconstruction while photographing. The first key images correspond to camera pose parameters, the camera pose parameters include a translation distance and a rotation angle, and the first key images meet at least one of the following: a difference of the translation distances between adjacent first key images is greater than a preset distance threshold, and a difference of the rotation angles between the adjacent first key images is greater than a preset angle threshold, which can help to expand the visual range of the first space as much as possible on the basis of referring to key images as less as possible in each reconstruction process, so as to improve the efficiency of three-dimensional reconstruction.

In above technical solutions, at least two frames of first key images for current reconstruction are acquired, a first space surrounding visual cones of the at least two frames of the first key images is determined, and the first key images are obtained by photographing a to-be-reconstructed target. Then based on this, a first feature map of the first space is obtained based on image information in the at least two frames of the first key images, the first feature map including first feature information of voxels in the first space, a first reconstruction result of the current reconstruction is obtained based on the first feature map, and then a second reconstruction result obtained by previous reconstruction is updated based on the first reconstruction result of the current reconstruction. Therefore, in each reconstruction process, three-dimensional reconstruction can be performed on the whole first space surrounding the visual cones of the at least two frames of the first key image, which can not only greatly reduce the computational load, but also reduce the probability of occurring stratification or dispersion of reconstruction results, so as to improve the real-time performance of three-dimensional reconstruction process and the smoothness of three-dimensional reconstruction results.

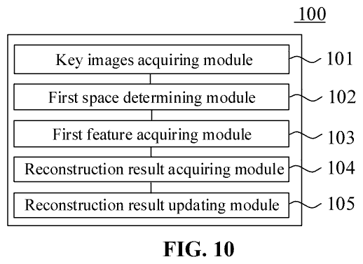

Referring to FIG. 10, FIG. 10 is a schematic frame diagram of an embodiment of an apparatus for reconstructing three-dimensional 100 according to the embodiments of the present disclosure. The apparatus for reconstructing three-dimensional 100 includes a key image acquiring module 101, a first space determining module 102, a first feature acquiring module 103, a reconstruction result acquiring module 104, and a reconstruction result updating module 105. The key image acquiring module 101 is configured to acquire at least two frames of first key images for current reconstruction. The first space determining module 102 is configured to determine a first space surrounding visual cones of the at least two frames of the first key images. The first key images are obtained by photographing a to-be-reconstructed target. The first feature acquiring module 103 is configured to obtain a first feature map of the first space based on image information in the at least two frames of the first key images. The first feature map includes first feature information of voxels in the first space. The reconstruction result acquiring module 104 is configured to obtain a first reconstruction result of the current reconstruction based on the first feature map. The reconstruction result updating module 105 is configured to update, based on the first reconstruction result of the current reconstruction, a second reconstruction result obtained by previous reconstruction.

In some disclosed embodiments, the apparatus for reconstructing three-dimensional 100 further includes a second feature acquiring module. The second feature acquiring module is configured to perform feature extraction on each frame of the first key images respectively to obtain second feature maps of the first key images. The first feature acquiring module 103 is configured to obtain the first feature map of the first space based on second feature information in the second feature map corresponding to each voxel of the first space.

In some disclosed embodiments, the first feature acquiring module 103 includes a feature information extraction sub-module. The feature information extraction sub-module is configured to extract the second feature information corresponding to the voxel from the second feature map of each frame of the first key images respectively. The first feature acquiring module 103 includes a feature information fusion sub-module. The feature information fusion sub-module is configured to fuse second feature information of the at least two frames of the first key images respectively corresponding to the voxel to obtain the first feature information of the voxel. The first feature acquiring module 103 includes a first feature information acquiring sub-module. The first feature information acquiring sub-module is configured to obtain the first feature map of the first space based on the first feature information of each voxel of the first space.

In some disclosed embodiments, the feature information fusion sub-module is configured to take an average value of the second feature information of various frames of the first key images respectively corresponding to the voxel as the first feature information of the voxel.

In some disclosed embodiments, the first feature acquiring module 103 further includes a feature information setting sub-module. The feature information setting sub-module is configured to take preset feature information as the first feature information of the voxel in a case that second feature information corresponding to the voxel is not extracted from the second feature map of each frame of the first key images.

In some disclosed embodiments, the second feature map of each frame of the first key images includes a preset number of second feature maps corresponding to different resolutions. The first space includes a preset number of first spaces corresponding to the different resolutions. The higher the resolution is, the smaller the size of voxels in the first space is. The first feature map includes a preset number of first feature maps corresponding to the different resolutions, and each of the first feature maps is obtained based on second feature information of a second feature map with a same resolution.

In some disclosed embodiments, the reconstruction result acquiring module 104 includes a resolution selection sub-module. The resolution selection sub-module is configured to select one of the resolutions as a current resolution successively in an order of the resolutions from low to high. The reconstruction result acquiring module 104 includes a feature map update sub-module. The feature map update sub-module is configured to upsample a first reconstruction result corresponding to a resolution selected in last time, and fuse the upsampled first reconstruction result with a first feature map corresponding to the current resolution to obtain a fused feature map corresponding to the current resolution. The reconstruction result acquiring module 104 includes a reconstruction result acquiring sub-module. The reconstruction result acquiring sub-module is configured to obtain, based on the fused feature map, a first reconstruction result corresponding to the current resolution. The reconstruction result acquiring module 104 includes a loop performing sub-module. The loop performing sub-module is configured to re-perform the step of selecting one of the resolutions as the current resolution successively in the order of the resolutions from low to high and subsequent steps in combination with the above resolution selection sub-module, feature map update sub-module and reconstruction result acquiring sub-module in the case that the current resolution is not the highest resolution. The reconstruction result acquiring module 104 includes a first result determination sub-module. The first result determination sub-module is configured to take the first reconstruction result corresponding to the current resolution as the final first reconstruction result of the current reconstruction in a case that the current resolution is the highest resolution.

In some disclosed embodiments, the reconstruction result acquiring module 104 includes a result prediction sub-module. The result prediction sub-module is configured to perform prediction based on the first feature map to obtain a first reconstruction value of each voxel in the first space and a probability value of the first reconstruction value within a preset value range. The first reconstruction value is configured to represent a distance between the voxel and an associated object surface in the to-be-reconstructed target. The reconstruction result acquiring module 104 includes a voxel selection sub-module. The voxel selection sub-module is configured to select voxels whose probability values meet a preset condition in the first space. The reconstruction result acquiring module 104 includes a second result determination sub-module. The second result determination sub-module is configured to obtain the first reconstruction result of the current reconstruction based on first reconstruction values of the selected voxels.

In some disclosed embodiments, the first reconstruction result includes first reconstruction values of the voxels in the first space, the second reconstruction result includes second reconstruction values of the voxels in a second space, the second space is a total space surrounding visual cones of previously reconstructed second key images, and the first reconstruction value and the second reconstruction value are used to represent distances between the voxels and associated object surfaces in the to-be-reconstructed target. The reconstruction result update module 105 is configured to update, based on the first reconstruction values of the voxels in the first space, the second reconstruction values corresponding to the voxels in the second space.

In some disclosed embodiments, the associated object surface is an object surface closest to the voxel in the to-be-reconstructed target.

In some disclosed embodiments, the first reconstruction result is obtained by using a three-dimensional reconstruction model. The reconstruction result acquiring module 104 includes a hidden layer state acquiring sub-module. The hidden layer state acquiring sub-module is configured to acquire a first historical hidden layer state obtained by a fusion network of the three-dimensional reconstruction model in a process of previous reconstruction. The first historical hidden layer state includes state values corresponding to voxels in a second space, and the second space is a total space surrounding visual cones of previously reconstructed second key images. The reconstruction result acquiring module 104 includes the hidden layer state extraction sub-module. The hidden layer state extraction sub-module is configured to extract state values corresponding to the voxels in the first space from the first historical hidden layer state as a second historical hidden layer state. The reconstruction result acquiring module 104 includes a hidden layer state update sub-module. The hidden layer state update sub-module is configured to update, based on the fusion network, the state values in the second historical hidden layer state based on the first feature map to obtain a current hidden layer state. The reconstruction result acquiring module 104 includes a reconstruction result prediction sub-module. The reconstruction result prediction sub-module is configured to perform prediction on the current hidden layer state by using the three-dimensional reconstruction model to obtain the first reconstruction result.

In some disclosed embodiments, when the current reconstruction is a first time of reconstruction, the state values in the first historical hidden layer state are preset state values.

In some disclosed embodiments, the fusion network includes a Gated Recurrent Unit.

In some disclosed embodiments, the three-dimensional reconstruction model further includes a prediction network, and the reconstruction result prediction sub-module is configured to perform prediction on the current hidden layer state based on the prediction network to obtain the first reconstruction result.

In some disclosed embodiments, the reconstruction result acquiring module 104 includes a geometric feature extraction sub-module. The geometric feature extraction sub-module is configured to extract geometric information from the first feature map to obtain a geometric feature map. The geometric feature map includes geometric information of the voxels. The hidden layer state update sub-module is configured to update the state values in the second historical hidden layer state based on the geometric feature map to obtain the current hidden layer state.

In some disclosed embodiments, the reconstruction result acquiring module 104 further includes a historical state update sub-module. The historical state update sub-module is configured to update, based on state values in the current hidden layer state, state values of corresponding voxels in the first historical hidden layer state correspondingly.

In some disclosed embodiments, the at least two frames of the first key images are acquired in a process of photographing the to-be-reconstructed target. The first key images correspond to camera pose parameters, the camera pose parameters include a translation distance and a rotation angle, and the first key images meet at least one of the following: a difference of the translation distances between adjacent first key images is greater than a preset distance threshold, and a difference of the rotation angles between the adjacent first key images is greater than a preset angle threshold.

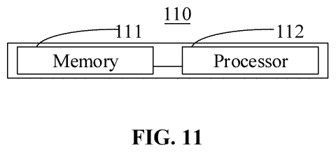

Referring to FIG. 11, FIG. 11 is a schematic frame diagram of an embodiment of an electronic device 110 according to the embodiments of the present disclosure. The electronic device 110 includes a memory 111 and a processor 112 coupled to each other, and the processor 112 is configured to execute program instructions stored in the memory 111 to implement the steps of any of the above method embodiments for reconstructing three-dimensional. In an implementation scenario, the electronic device 110 may include, but is not limited to, a microcomputer and a server. In addition, the electronic device 110 may also include mobile devices such as mobile phones, notebook computers, and tablet computers, which are not limited herein.

The processor 112 is configured to control itself and the memory 111 to implement the steps of any of method embodiments for reconstructing three-dimensional described above. The processor 112 may also be referred to as a Central Processing Unit (CPU). The processor 112 may be an integrated circuit chip with signal processing capability. The processor 112 may also be a general-purpose processor, a Digital Signal Processor (DSP), an Application Specific Integrated Circuit (ASIC), a Field-Programmable Gate Array (FPGA), or other Programmable logic devices, discrete gate or transistor logic devices, discrete hardware components. A general-purpose processor may be a microprocessor or the processor may be any conventional processor or the like. In addition, the processor 112 may be jointly implemented by an integrated circuit chip.

The above solution can improve the real-time performance of the three-dimensional reconstruction process and the smoothness of the three-dimensional reconstruction result.

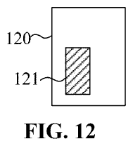

Referring to FIG. 12, FIG. 12 is a schematic frame diagram of an embodiment of a computer-readable storage medium according to the embodiments of the present disclosure. The computer-readable storage medium 120 stores program instructions 121 that can be executed by the processor, and the program instructions 121 are configured to implement the steps of any of the above method embodiments for reconstructing three-dimensional.

The above solution improves the real-time performance of the three-dimensional reconstruction process and the smoothness of the three-dimensional reconstruction result.

In some embodiments, the functions or modules included in the apparatus provided by the embodiments of the present disclosure may be configured to execute the methods described in the above method embodiments, and the implementation of the above method embodiments may refer to the descriptions of the above method embodiments. For the sake of brevity, elaborations are omitted herein.

The above descriptions of the various embodiments tend to emphasize the differences between the various embodiments, and the similarities or similarities may be referred to each other. For the sake of brevity, elaborations are omitted herein.

In the several embodiments provided in the present disclosure, it should be understood that the disclosed method and apparatus may be implemented in other manners. For example, the apparatus embodiments described above are only illustrative. For example, the division of modules or units is only a logical function division. In actual implementation, there may be other division manners. For example, units or components may be combined or integrated to another system, or some features may be ignored, or not performed. On the other hand, the shown or discussed mutual coupling or direct coupling or communication connection may be indirect coupling or communication connection through some interfaces, apparatus or units, which may be in electrical, mechanical or other forms.

Units described as separate components may or may not be physically separated, and components shown as units may or may not be physical units, that is, may be located in one place, or may be distributed over network units. Some or all of the units may be selected according to actual needs to implement the purpose of the solution in the embodiments of the present disclosure.

In addition, each functional unit in each embodiment of the present disclosure may be integrated into one processing unit, or each unit may exist physically alone, or two or more units may be integrated into one unit. The above integrated units may be implemented in the form of hardware, or may be implemented in the form of software functional units.

The integrated unit, if implemented as a software functional unit and sold or used as a stand-alone product, may be stored in a computer-readable storage medium. Based on this understanding, the essence of the technical solutions of the embodiments of the present disclosure, or the part that contributes to some implementations, or all or part of the technical solution can be embodied in the form of software product. The computer software products are stored in a storage medium, and include several instructions for causing a computer device (which may be a personal computer, a server, or a network device, etc.) or a processor to execute all or part of the steps of the methods in the various embodiments of the present disclosure. The above storage medium includes: U disk, mobile hard disk, Read-Only Memory (ROM), Random Access Memory (RAM), magnetic disk or optical disk and other medium that can store program codes.

Embodiments of the present disclosure disclose a method and apparatus for reconstructing three-dimensional, a device and a storage medium. The method for reconstructing three-dimensional includes the following operations. At least two frames of first key images for current reconstruction are acquired. A first space surrounding visual cones of the at least two frames of the first key images is determined. The first key images are obtained by photographing a to-be-reconstructed target. A first feature map of the first space is determined based on image information in the at least two frames of the first key images. The first feature map includes first feature information of voxels in the first space. A first reconstruction result of the current reconstruction is obtained based on the first feature map. A second reconstruction result obtained by previous reconstruction is updated based on the first reconstruction result of the current reconstruction.

What is claimed is:

1. A method for reconstructing three-dimensional, performed by an electronic device, comprising:
acquiring at least two frames of first key images for current reconstruction;
determining a first space surrounding visual cones of the at least two frames of the first key images, wherein the first key images are obtained by photographing a to-be-reconstructed target;
obtaining a first feature map of the first space based on image information in the at least two frames of the first key images, wherein the first feature map comprises first feature information of voxels in the first space;
determining a first reconstruction result of the current reconstruction based on the first feature map;
updating, based on the first reconstruction result of the current reconstruction, a second reconstruction result obtained by previous reconstruction.

2. The method of claim 1, after acquiring the at least two frames of the first key images for the current reconstruction, further comprising:
performing feature extraction on each frame of the first key images respectively to obtain a second feature map of each frame of the first key images;
wherein obtaining the first feature map of the first space based on the image information in the at least two frames of the first key images comprises:
obtaining the first feature map of the first space based on second feature information in the second feature map corresponding to each voxel of the first space.

3. The method of claim 2, wherein obtaining the first feature map of the first space based on the second feature information in the second feature map corresponding to each voxel in the first space comprises:
extracting the second feature information corresponding to the voxel from the second feature map of each frame of the first key images respectively;
fusing second feature information of the at least two frames of the first key images respectively corresponding to the voxel to obtain the first feature information of the voxel; and
obtaining the first feature map of the first space based on the first feature information of each voxel of the first space.

4. The method of claim 3, wherein fusing second feature information of the at least two frames of the first key images respectively corresponding to the voxel to obtain the first feature information of the voxel comprises at least one of the following:
taking an average value of the second feature information of the at least two frames of the first key images respectively corresponding to the voxel as the first feature information of the voxel; and
taking preset feature information as the first feature information of the voxel in a case that second feature information corresponding to the voxel is not extracted from the second feature map of each frame of the first key images.

5. The method of claim 2, wherein the second feature map of each frame of the first key images comprises a preset number of second feature maps corresponding to different resolutions, the first space comprises a preset number of first spaces corresponding to the different resolutions, the first feature map comprises a preset number of first feature maps corresponding to the different resolutions, and each of the first feature maps is obtained based on second feature information of a second feature map with a same resolution.

6. The method of claim 5, wherein determining the first reconstruction result of the current reconstruction based on the first feature map comprises:
selecting one of the resolutions as a current resolution successively in an order of the resolutions from low to high;
upsampling a first reconstruction result corresponding to a resolution selected in last time,
fusing the upsampled first reconstruction result with a first feature map corresponding to the current resolution to obtain a fused feature map corresponding to the current resolution;
obtaining, based on the fused feature map, a first reconstruction result corresponding to the current resolution;
in a case that the current resolution is not a highest resolution, re-performing the step of selecting one of the resolutions as the current resolution successively in the order of the resolutions from low to high and subsequent steps; and
in a case that the current resolution is the highest resolution, taking the first reconstruction result corresponding to the current resolution as the first reconstruction result of the current reconstruction.

7. The method of claim 1, wherein determining the first reconstruction result of the current reconstruction based on the first feature map comprising:
performing prediction based on the first feature map to obtain a first reconstruction value of each voxel in the first space and a probability value of the first reconstruction value within a preset value range, wherein the first reconstruction value is used to represent a distance between the voxel and an associated object surface in the to-be-reconstructed target;
selecting voxels whose probability values meet a preset condition in the first space; and
obtaining the first reconstruction result of the current reconstruction based on first reconstruction values of the selected voxels.

8. The method of claim 1, wherein the first reconstruction result comprises first reconstruction values of the voxels in the first space, the second reconstruction result comprises second reconstruction values of the voxels in a second space, the second space is a total space surrounding visual cones of previously reconstructed second key images, and the first reconstruction value and the second reconstruction value are used to represent distances between the voxels and associated object surfaces in the to-be-reconstructed target;
wherein updating, based on the first reconstruction result of the current reconstruction, the second reconstruction result obtained by previous reconstruction comprises:
updating, based on the first reconstruction values of the voxels in the first space, the second reconstruction values corresponding to the voxels in the second space.

9. The method of claim 7, wherein the associated object surface is an object surface closest to the voxel in the to-be-reconstructed target.

10. The method of claim 1, wherein the first reconstruction result is obtained by using a three-dimensional reconstruction model, and determining the first reconstruction result of the current reconstruction based on the first feature map comprises:
acquiring a first historical hidden layer state obtained by a fusion network of the three-dimensional reconstruction model in a process of previous reconstruction, wherein the first historical hidden layer state comprises state values corresponding to voxels in a second space, and the second space is a total space surrounding visual cones of previously reconstructed second key images;
extracting state values corresponding to the voxels in the first space from the first historical hidden layer state as a second historical hidden layer state;
updating, in the fusion network, the state values in the second historical hidden layer state based on the first feature map to obtain a current hidden layer state; and
performing prediction on the current hidden layer state by using the three-dimensional reconstruction model to obtain the first reconstruction result.

11. The method of claim 10, wherein when the current reconstruction is a first time of reconstruction, the state values in the first historical hidden layer state are preset state values.

12. The method of claim 10, wherein the fusion network comprises: a Gated Recurrent Unit, the three-dimensional reconstruction model further comprises a prediction network, and wherein performing prediction on the current hidden layer state by using the three-dimensional reconstruction model to obtain the first reconstruction result comprises:
performing prediction on the current hidden layer state based on the prediction network to obtain the first reconstruction result.

13. The method of claim 10, before updating the state values in the second historical hidden layer state based on the first feature map to obtain the current hidden layer state, further comprising:
extracting geometric information from the first feature map to obtain a geometric feature map, wherein the geometric feature map comprises geometric information of the voxels,
wherein updating the state values in the second historical hidden layer state based on the first feature map to obtain the current hidden layer state comprises:
updating the state values in the second historical hidden layer state based on the geometric feature map to obtain the current hidden layer state.

14. The method of claim 10, after updating the state values in the second historical hidden layer state based on the first feature map to obtain the current hidden layer state, further comprising:
updating, based on state values in the current hidden layer state, state values of corresponding voxels in the first historical hidden layer state correspondingly.

15. The method of claim 1, wherein acquiring the at least two frames of the first key images for current reconstruction comprises:
acquiring the at least two frames of the first key images in a process of photographing the to-be-reconstructed target.

16. The method of claim 1, wherein the first key images correspond to camera pose parameters, the camera pose parameters comprise a translation distance and a rotation angle, and the first key images meet at least one of the following: a difference of the translation distances between adjacent first key images is greater than a preset distance threshold, and a difference of the rotation angles between the adjacent first key images is greater than a preset angle threshold.

17. An electronic device, comprising a memory and a processor that are mutually coupled, wherein the processor is configured to execute program instructions stored in the memory to implement the following operations:
acquiring at least two frames of first key images for current reconstruction;
determining a first space surrounding visual cones of the at least two frames of the first key images, wherein the first key images are obtained by photographing a to-be-reconstructed target;
obtaining a first feature map of the first space based on image information in the at least two frames of the first key images, wherein the first feature map comprises first feature information of voxels in the first space;
determining a first reconstruction result of the current reconstruction based on the first feature map;
updating, based on the first reconstruction result of the current reconstruction, a second reconstruction result obtained by previous reconstruction.

18. The electronic device of claim 17, wherein after acquiring the at least two frames of the first key images for the current reconstruction, the operations further comprise:
performing feature extraction on each frame of the first key images respectively to obtain a second feature map of each frame of the first key images;
wherein obtaining the first feature map of the first space based on the image information in the at least two frames of the first key images comprises:
obtaining the first feature map of the first space based on second feature information in the second feature map corresponding to each voxel of the first space.

19. The electronic device of claim 18, wherein obtaining the first feature map of the first space based on the second feature information in the second feature map corresponding to each voxel in the first space comprises:
extracting the second feature information corresponding to the voxel from the second feature map of each frame of the first key images respectively;
fusing second feature information of the at least two frames of the first key images respectively corresponding to the voxel to obtain the first feature information of the voxel; and
obtaining the first feature map of the first space based on the first feature information of each voxel of the first space.

20. A non-transitory computer-readable storage medium on which program instructions are stored, wherein when the program instructions are executed by a processor, the method comprising the following operations is implemented:
acquiring at least two frames of first key images for current reconstruction;
determining a first space surrounding visual cones of the at least two frames of the first key images, wherein the first key images are obtained by photographing a to-be-reconstructed target;
obtaining a first feature map of the first space based on image information in the at least two frames of the first key images, wherein the first feature map comprises first feature information of voxels in the first space;
determining a first reconstruction result of the current reconstruction based on the first feature map;
updating, based on the first reconstruction result of the current reconstruction, a second reconstruction result obtained by previous reconstruction.
